(19) United States
(12) Patent Application Publication
(10) Pub. No.: US 2018/0352714 A1
(43) Pub. Date: Dec. 13, 2018

(54) SHOVEL-CUM-SPADE TOOL

(71) Applicant: Jock Renau PHELPS, Lake City, FL (US)

(72) Inventor: Jock Renau PHELPS, Lake City, FL (US)

(21) Appl. No.: 15/983,440

(22) Filed: May 18, 2018

Related U.S. Application Data
(60) Provisional application No. 62/517,127, filed on Jun. 8, 2017.

(51) Int. Cl. A01B 1/02

(52) U.S. Cl. CPC A01B 1/02; A01B 1/024

(57) ABSTRACT

Disclosed is a shovel-cum-spade tool for use in the field of construction, framing, gardening and so forth. The tool primarily includes an implement part and a handle, where the implement part further includes a front portion and a rear portion. The front portion is integral with and inclined to the rear portion. Also, the front portion includes two or more arcuate leading edges, which majorly contributes in efficiently cutting through material such as soil and the like.

### FIELD OF THE INVENTION

The present disclosure relates generally to a mechanical digging tool, more specifically, the disclosure relates to a tool that is capable of digging, cutting, slicing, edging, skimming, lifting which in turn may be used as a shovel as well as spade at the same time.

### BACKGROUND

Use of digging tools such as a shovel or a spade in the field of construction, farming, and gardening is well known. Other than digging, such tools may be further used for lifting, moving, cutting and mixing material, such as soil, coal, gravel, snow, sand or ore.

Conventionally, based on type of jobs (for example, digging, lifting, and moving material) different specific tools may be used that are designed for performing such specific jobs. For example, a spade may be used for digging or cutting material, whereas a shovel may be used for lifting or moving such dug or cut material. Typically, use of different tools for getting multiple work done is associated with various problems. For example, buying separate tools, carrying such tools to a jobsite, storages of such tools after use and the like. Most importantly, using different tools sequentially as per their need increases an overall completion time of a task, and makes such task cumbersome.

Further, numerous attempts have been made to make a single tool that can perform multiple functions (such as digging, lifting and moving material). However such tools suffer from a major problem of being inefficient in doing the multiple functions as it is challenging to strike a balance in multiple design aspects of a tool such as blade curve angle, angle of blade inclination to ground, weight of the tool itself and the like.

Therefore, in light of the foregoing discussion, there exists a need to overcome the aforementioned drawbacks associated with conventional tools that are used in the field of construction, farming, gardening and so forth.

### SUMMARY

Various embodiments provide multipurpose tools for various mechanical purposes such as digging, cutting, slicing, edging, skimming and lifting.

In an embodiment, a mechanical digging tool is disclosed. The mechanical digging tool comprises an implement part and a handle. The implement part is configured with a front portion and a rear portion. The front portion is inclined to the rear portion at an angle ranging from about 25°-30°. The front portion is configured with at least two arcuate leading edges. The handle is coupled to the implement part to operate the implement part.

In another embodiment, a shovel-cum spade tool is disclosed. The shovel-cum spade tool comprises an implement part and a handle. The implement part is configured with a front portion and a rear portion. The front portion is inclined to the rear portion at an angle ranging from about 25°-30°. The front portion includes at least two arcuate leading edges. The handle is coupled to the front portion of the implement part.

### BRIEF DESCRIPTION OF THE DRAWINGS

The following detailed description of illustrative embodiments is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a side view of a shovel-cum-spade tool, in accordance with an embodiment of the present disclosure;

FIG. 2 is a top view of an implement part of the tool of FIG. 1, in accordance with an embodiment of the present disclosure;

FIGS. 3 and 4 are rear and front sectional views of the implement part of FIG. 2, respectively, in accordance with various embodiments of the present disclosure; and

FIG. 5 is a schematic view of foot cleats to be configured on an implement part, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

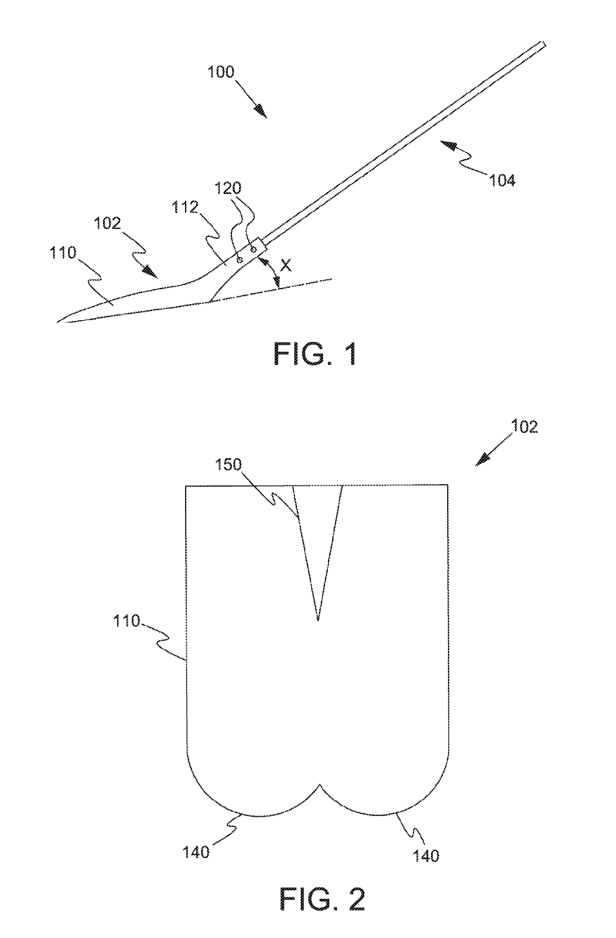

Referring now to the drawings, particularly by their reference numbers, FIG. 1 is a side view of a shovel-cum-spade tool 100, in accordance with an embodiment of the present disclosure. As shown, the tool 100 includes an implement part 102 (or blade) and a handle 104 coupled to the implement part 102. The implement part 102 includes a front portion 110 and a rear portion 112. Furthermore, the front portion 110 is integral with and inclined to the rear portion 112. According to an embodiment, the front portion 110 is inclined to the rear portion 112 at an acute angle X, which may be in a range of about 25 degrees to about 30 degrees.

In a preferred embodiment, the angle X may be 27 degrees. Further, with respect to FIG. 1, the angle X allows the handle 104 of the tool 100 to be at an optimal position which is not too high or not too low for lifting. This design of the handle 104 gives a user an ease of working, i.e. lessening strain on back, gluteus, legs, and arms. Further, the angle X between the front portion 110 and the rear portion 112 (i.e. angle from rear to front of the tool 100) aligns with the angle of the handle 104. This uniformity of structural configuration (or design) increases the overall efficiency and effectiveness of the tool 100.

In one embodiment, the ratio of the front portion 110 to the rear portion 112 is 12:7. For example, the front portion 110 and the rear portion 112 may be configured to have lengths of about 12 inches and 7 inches, respectively. Additionally, the handle 104 may be configured to have a length of about 38 inches. In one embodiment, the implement part 102 may be configured to have a width in a range of 8 to 12 inches, particularly 9.6 inches. It is to be understood that the dimensions of the front portion 110, the rear portion 112 and the handle 104 are exemplary and may be altered based on different embodiments. For example, in one embodiment, the implement part 102 of the tool 100 may be configured to be wide and long for moving or lifting or cleaning snow/ice, otherwise the implement part 102 may be made shorter, compact, and narrower for more tunneling use.

It may be appreciated that the tool 100 primarily relates to the implement part 102 and the handle 104 is disclosed as an optional feature. In one embodiment, the handle 104 may be made of any suitable material, such a wood, metal, plastic or any combination thereof. Further, the implement part 102 may be made of metal, such as steel, iron, copper, or any suitable alloy. Moreover, the handle 104 may be coupled to the implement part 102 using various techniques. For example the implement part 102 may be configured to have an opening adapted to receive an end portion of the handle 104 therein. Thereafter, the end portion of the handle 104 may be coupled to the opening of the implement part 102 using fasteners, such as bolts (or screws) 120.

Referring now to FIG. 2, illustrated is a top view of the implement part 102 of the tool 100 of FIG. 1, in accordance with an embodiment of the present disclosure. Specifically, FIG. 2 illustrates a top view of the front portion 110 of the implement part 102. As shown, the front portion 110 includes arcuate leading edges 140. According to an embodiment, the front portion 110 includes two arcuate leading edges 140. In another embodiment, the front portion 110 may be configured to have more than two arcuate leading edges, i.e. three or four arcuate leading edges.

According to an embodiment, the arcuate leading edges 140 are configured to be planner, i.e. almost flat. In an example, the arcuate leading edges 140 may have an angle of about 180 degrees, particularly 176 degrees there between (best shown in FIG. 4 with the help an angle Z). Moreover, the arcuate leading edges 140 are configured to have sharpened ends. In one embodiment, the arcuate leading edges 140 are sharpened to have about 20 degrees on one side (i.e. single beveled). This allows the tool 100 to have an optimal angle for the arcuate leading edges 140 to efficiently cut through material such as soil and the like. In one embodiment, the arcuate leading edges 140 may constitute about 20% to 25%, particularly about 23%, of the implement part 102. Therefore, around 23% of the implement part 102 is effectively used for cutting or digging or penetration, and rest of the implement part 102 (of about 77%) is used for lifting and moving material. Therefore, shape and angles of the implement part 102 (which essentially includes the arcuate leading edges 140) allows the tool 100 to efficiently perform multiple tasks, such as digging, lifting, moving, cutting and mixing material.

FIG. 2 also depicts an extension 150 of the opening (see, opening 152) configured to receive the end portion of the handle 104 to engage the handle 104 therein. The extension 150 may be a raised or an elevated portion centrally configured on the front portion 110 of the implement part 102.

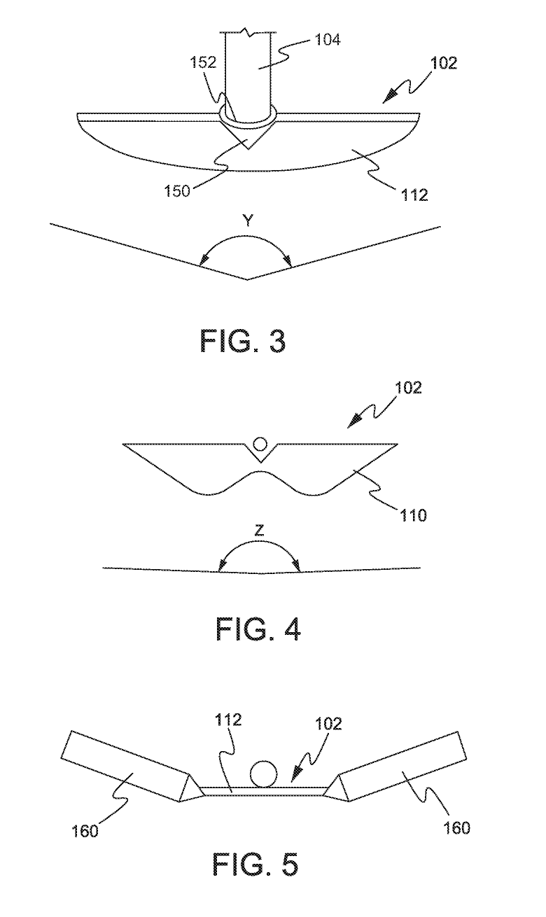

Referring now to FIGS. 3 and 4, illustrated are rear and front sectional views of the implement part 102 of FIG. 2, respectively, in accordance with various embodiments of the present disclosure. As shown in FIG. 3, the sectional view (particularly the rear sectional view) of the implement part 102 is configured to have an angle Y for a rear portion, i.e. the rear portion 112 of the implement part 102. In one embodiment, the angle Y may be in a range of 145 degrees to 155 degrees, and particularly 149 degrees. The handle 104 is coupled to the implement part 102, particularly with the extension 150 (via the opening 152) to operate the implement part 102. The implement part 102 has a hollow portion (i.e. the opening 152) to insert the handle 104 into it. Further, as shown in FIG. 4, the sectional view (particularly the front sectional view) of the implement part 102 is configured to have an angle Z for a front portion i.e. the front portion 110 of the implement part 102. In an embodiment, the angle Z may be in a range of 170 degrees to 180 degrees, and particularly 176 degrees.

Referring now to FIG. 5, illustrated is a schematic view of foot cleats to be configured on an implement part, such as the implement part 102, in accordance with an embodiment of the present disclosure. Specifically, as shown, the implement part 102 includes foot cleats 160 configured on (or integral with) the rear portion 112 of the implement part 102. Specifically, the foot cleats 160 are configured on a top edge of the rear portion 112, and acts as a stop for the handle 104 with respect to the implement part 102. In use, a person may rest his one foot on one of the foot cleats 160 to apply pressure for pushing or inserting the implement part 102 (particularly the arcuate leading edges 140 thereof) through a material, such as soil. In one embodiment, the foot cleats 160 may be configured to have a width of about half inches.

Based on the foregoing, various embodiments of the present disclosure provide shovel-cum-spade tools that can be used in the field of construction, framing, gardening and so forth. Such disclosed tools are capable of overcoming the drawbacks associated with conventional tools that are used in the field of construction, framing, gardening and so forth. For instance, shape and angles of the implement part (which essentially includes the arcuate leading edges) of the shovel-cum-spade tools allows such tools to efficiently perform multiple tasks, such as digging, lifting, moving, cutting and mixing material.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

What is claimed is:

1. A mechanical digging tool, comprising:
an implement part configured with a front portion and a rear portion, wherein the front portion is inclined to the rear portion at an angle ranging from 25°-30°, and wherein the front portion is configured with at least two arcuate leading edges; and
a handle coupled to the implement part to operate the implement part.

2. The tool as claimed in claim 1 wherein the front portion is inclined to the rear portion at 27°.

3. The tool as claimed in claim 1 further comprising of a foot cleat configured on the implement part.

4. The tool as claimed in claim 3 wherein the foot cleat is configured on a top edge of the rear portion.

5. The tool as claimed in claim 1 wherein ratio of length of the front portion to length of the rear portion is 12:7.

6. The tool as claimed in claim 1 wherein the implement part is configured to have a width in a range of about 8 to 12 inches.

7. The tool as claimed in claim 1 wherein the handle is coupled to the implement part by using fasteners.

8. The tool as claimed in claim 1, wherein the implement part further comprises an extension raised from the front portion, wherein the handle is coupled to the extension.

9. The tool as claimed in claim 8, wherein the extension comprises an opening to receive at least an end portion of the handle to engage the handle therein.

10. The tool as claimed in claim 1 wherein the implement part is made of at least one of steel, iron and copper.

11. The tool as claimed in claim 1 wherein the handle is made of a suitable material comprising at least one of wood, plastic and metal.

12. The tool as claimed in claim 1 wherein the arcuate leading edges have an angle of about 180 degrees there between.

13. The tool as claimed in claim 1 wherein the arcuate leading edges are configured to have sharpened ends.

14. The tool as claimed in 11 wherein the arcuate leading edges are sharpened to have about 20 degrees on one side.

15. The tool as claimed in claim 1 wherein the arcuate leading edges constitute about 20% to 25% of the implement part.

16. The tool as claimed in claim 1, wherein the at least two arcuate leading edges comprises four arcuate leading edges.

17. A shovel-cum spade tool, comprising:
an implement part configured with a front portion and a rear portion wherein the front portion is inclined to the rear portion at an angle ranging from about 25°-30°, the front portion comprising at least two arcuate leading edges; and
a handle coupled to the front portion of the implement part.

18. The tool as claimed in claim 17, wherein the implement part further comprises an extension raised from the front portion, wherein the handle is coupled to the extension.

19. The tool as claimed in claim 18, wherein the extension comprises an opening to receive at least an end portion of the handle to engage the handle therein.

20. The tool as claimed in claim 17, wherein the front portion is inclined to the rear portion at 27°.
